(19) United States
(12) Patent Application Publication
(10) Pub. No.: US 2011/0246546 A1
(43) Pub. Date: Oct. 6, 2011

(54) DATA STORAGE APPARATUS

(75) Inventors: Simon Hughes, Cheshire (GB); Daniel Braund, Cumbria (GB)

(73) Assignee: NUCLEAR DECOMMISSIONING AUTHORITY, Cumbria (UK)

(21) Appl. No.: 13/139,129

(22) PCT Filed: Dec. 10, 2009
(86) PCT No.: PCT/GB09/51685

§ 371 Date: Jun. 10, 2011

(30) Foreign Application Priority Data
Dec. 12, 2008 (GB) 0822698.7

(51) Int. Cl. G06F 17/30

(52) U.S. Cl. 707/822; 707/E17.005

(57) ABSTRACT

Apparatus arranged to allow a user to input a plurality of values of data elements of a table being a baseline version of the table having a version number b, the apparatus being arranged to store the values of the data elements in a database in the form of one or more baseline version records, each record containing at least one of the values of the data elements, the apparatus being arranged to allow a user to input a revised value of one or more of the data elements of the table thereby to define a change dataset representing the value of one or more data elements of a (b+n)th version of the table that are different from the value of one or more corresponding data elements of the b'th version of the table, the apparatus being arranged to store the difference dataset by generating one or more further records of the database, each further record corresponding to a baseline version record of the database, each further record containing at least one value of a data element of the difference dataset, the apparatus being further arranged to store in the database an identifier indicative of an identity of the version of the table to which each of the one or more further records corresponds.

### FIELD OF THE INVENTION

The present invention relates to data storage apparatus. In particular, but not exclusively, the invention relates to apparatus for storing multiple versions of a table in a database.

### BACKGROUND

It is known to store a table of data elements in a database. The data elements may be stored in one or more fields of each of a plurality of records. One or more fields of a record may contain a data element corresponding to a value of a particular parameter. For example, the parameter may be the speed of a particular vehicle under prescribed conditions, for example at a given moment in time. One or more other fields of the record may contain values of one or more parameters indicative of the prescribed conditions.

For example, one field of a record may contain the identity of a year (e.g. ‘2007’) and another field may contain a carriage capacity or speed of a particular type of transportation type in a factory (e.g. a ‘truck’) in the year 2007.

The records of the database may be stored in the form of a spreadsheet in the memory of a computer system.

Once a dataset representing a table has been stored, it may be required to make a change to a value of a data element of the table. This is typically done by making a permanent change to the value stored in the relevant field of the corresponding record, e.g. by overwriting the record with a changed record. Alternatively a new version of the table may be stored as a separate table in the database.

A disadvantage of overwriting previous versions of a table is that the previous versions are no longer accessible for audit and/or other review purposes. Furthermore, in prior art systems a reliance must be placed on persons making amendments to the dataset to include documentation of changes whenever such changes are made. This reliance exposes the process to error since such persons may fail to document a change, either wilfully or by mistake. Consequently, a person reviewing a dataset may be unable to identify records that have been changed since a previous version of the dataset was created.

In the case that new versions of a table are stored each time the table is changed, known systems can rapidly fill available storage resources since each version of a table may be many tens or hundreds of megabytes in size. Furthermore, unless a user has documented changes made when a new version of a table was stored, it can be difficult if not practically impossible to identify which data elements of a table have been changed. Painstaking manual comparison of one table with an earlier version of the table may be required in order to identify any such changes. In some cases tables are of such a size that such manual review is practically impossible.

### STATEMENT OF THE INVENTION

In a first aspect of the present invention there is provided apparatus arranged to allow a user to input a plurality of values of data elements of a table being a baseline version of the table having a version number b, the apparatus being arranged to store the values of the data elements in a database in the form of one or more baseline version records, each record containing at least one of the values of the data elements, the apparatus being arranged to allow a user to input a revised value of one or more of the data elements of the table thereby to define a change dataset representing the value of one or more data elements of a (b+n)th version of the table that are different from the value of one or more corresponding data elements of the b'th version of the table, the apparatus being arranged to store the difference dataset by generating one or more further records of the database, each further record corresponding to a baseline version record of the database, each further record containing at least one value of a data element of the difference dataset, the apparatus being further arranged to store in the database an identifier indicative of an identity of the version of the table to which each of the one or more further records corresponds.

This apparatus has the advantage that an amount of storage capacity required to store multiple versions of a table may be substantially reduced compared with some prior art apparatus without a requirement to delete a previous version of a table. This is because when a version of a table stored in the database is required to be updated whereby one or more data elements of the table are replaced with new data elements, the apparatus does not delete existing records of the table. Rather, values of data elements of a previous version of a table are retained. A new record is generated only for each record of the previous version of the table containing a data element whose value is to be changed.

Thus, in apparatus according to embodiments of the invention it is not necessary to generate and store records of a new version of a table corresponding to records of an original version of the table that remain unchanged when the new version of the table is created. A substantial saving in a size of a storage space required to store multiple versions of a given table may therefore be enjoyed in some embodiments.

Preferably the apparatus is arranged to output upon request the value of one or more data elements of an m'th version of the table stored in the database where m≦b+n.

This function can be readily and conveniently implemented using Scripted Query Language (SQL), e.g. mySQL™.

Preferably each record of the database is provided with an identifier indicative of the identity of the version of the table to which that record corresponds.

This feature facilitates rapid and efficient identification of records of the database corresponding to a given required version of a table.

More preferably each record is further provided with an identifier unique to that record.

Still more preferably each record containing a value of a data element of a difference dataset also contains a patch identifier, the patch identifier having a value corresponding to the value of the unique identifier of the baseline version record to which that record corresponds.

The patch identifier may have the same value as that of the unique identifier of the baseline version record to which that record corresponds.

The apparatus may be arranged to store a table in a normalised form.

Preferably the apparatus is arranged to store a table in a normalised form, wherein at least one further table is generated to store a content of one or more fields of a record being a content of one or more fields of a notional non-normalised table corresponding to the table in normalised form.

The apparatus is preferably arranged to execute a simulation tool software application for simulating an environment, the apparatus being arranged to store at least one table of input parameters for the simulation tool.

Preferably the simulation tool software application is arranged to access the database and to extract one or more data elements corresponding to a required version of a table stored in the database.

Alternatively or in addition the apparatus may be arranged to export to the simulation application data elements corresponding to a required version of a table stored in the database.

The apparatus is preferably arranged to receive an identifier corresponding to an identity of a person responsible for entering into the apparatus a data element of a difference dataset and to determine whether the identifier corresponds to a person authorised to enter a data element into the apparatus.

This has the advantage that auditing of changes to a table stored in the database is facilitated since the one or more persons responsible for changes to the table may be identified.

The apparatus may be arranged not to allow a data element to be stored in a database of the apparatus when the identifier received by the apparatus does not correspond to an authorised person.

The apparatus may be arranged to receive the identifier by means of one selected from amongst an RFID tag and reader, a keypad and a swipe card.

Preferably a data element corresponding to the identifier is stored in a field of the record corresponding to the data element of the difference dataset.

The apparatus is preferably arranged to output a required version of a table to a visual display unit of the apparatus upon request.

This feature has the advantage of allowing checking of a content of a table or line of a table by a user.

Preferably the apparatus is arranged to allow data elements to be input to the database by a user manually by means of an input device, the input device being optionally selected from amongst a keyboard, a mouse and a touch screen.

Preferably data elements may be input to the database from a file provided to or generated by the apparatus.

Preferably data elements may be input to the database from a file stored externally with respect to the database.

Preferably records of the database are provided with a field containing a baseline identifier, the baseline identifier providing an indication as to whether the record contains one or more data elements of a baseline version of the table, a baseline version being a reference version with respect to which one or more further records of the database represent one or more data elements of a difference dataset.

This feature has the advantage that a given version of a table may be set as a ‘baseline version’ with respect to which further versions of the table are considered to be modifications. This has the advantage of easing management of changes made to a table, and facilitates auditing of changes made to a table since all previous versions of the table stored in the database are retained and not overwritten.

Preferably the baseline identifier contains one or more prescribed characters, numerals or symbols if the record contains one or more data elements of a baseline version of the table.

This has the advantage of facilitating ready identification of one or more baseline versions of a table.

Preferably the baseline identifier of a record containing a data element of a difference dataset has a value corresponding to that of the version identifier of the corresponding record of the corresponding baseline version of the table.

The version identifier of each record is preferably determined with respect to a single baseline version of the table.

This has the advantage that any previous baseline version of a table and any required version of that baseline table may be readily reconstructed from the database.

In a second aspect of the invention there is provided a method of storing multiple versions of a table in a database, the method comprising: inputting a plurality of values of data elements of a table being a baseline version of the table having a version number b; storing the values of the data elements in a database in the form of one or more baseline version records, each record containing at least one of the values of the data elements; inputting a revised value of one or more of the data elements of the table thereby to define a difference dataset representing the value of one or more data elements of a (b+n)th version of the table that are different from the value of one or more corresponding data elements of the b'th version of the table; storing the difference dataset by generating one or more further records of the database, each further record corresponding to a baseline version record, each further record containing at least one value from the difference dataset; and storing in the database an identifier indicative of an identity of the version of the table to which each of the one or more further records corresponds.

Embodiments of the invention will now be described with reference to the accompanying figures in which:

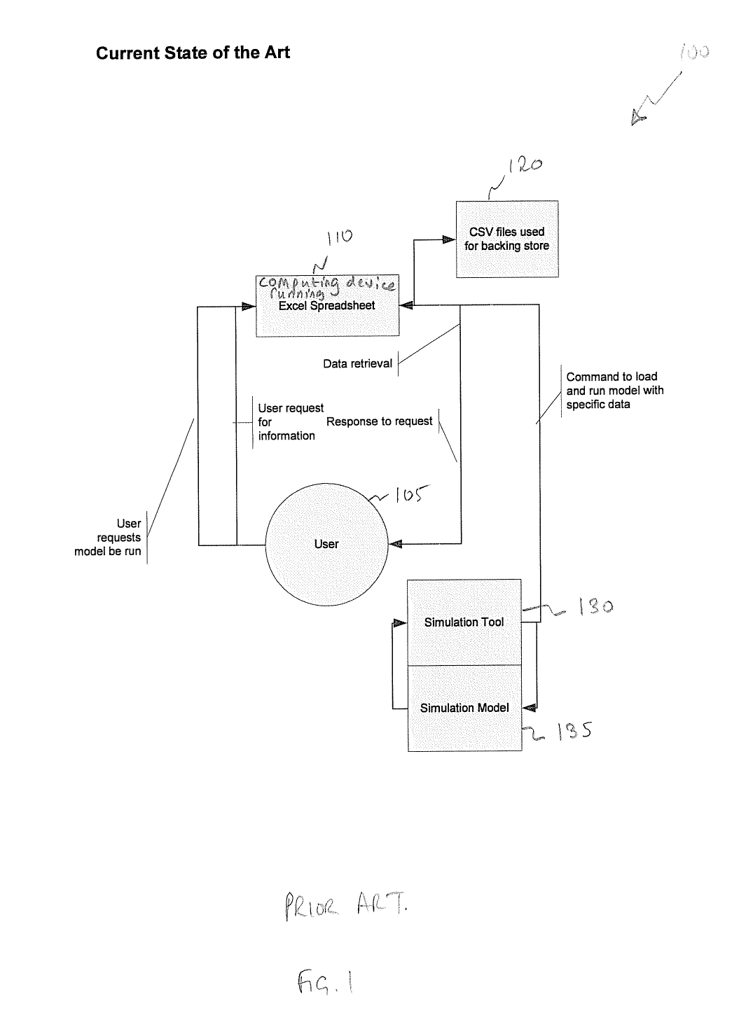

FIG. 1 shows a known system for inputting a dataset comprising data elements to a computing apparatus, the computing apparatus being arranged to run a simulation model using the data elements as an input parameter dataset for the model, the apparatus allowing datasets to be changed by a user;

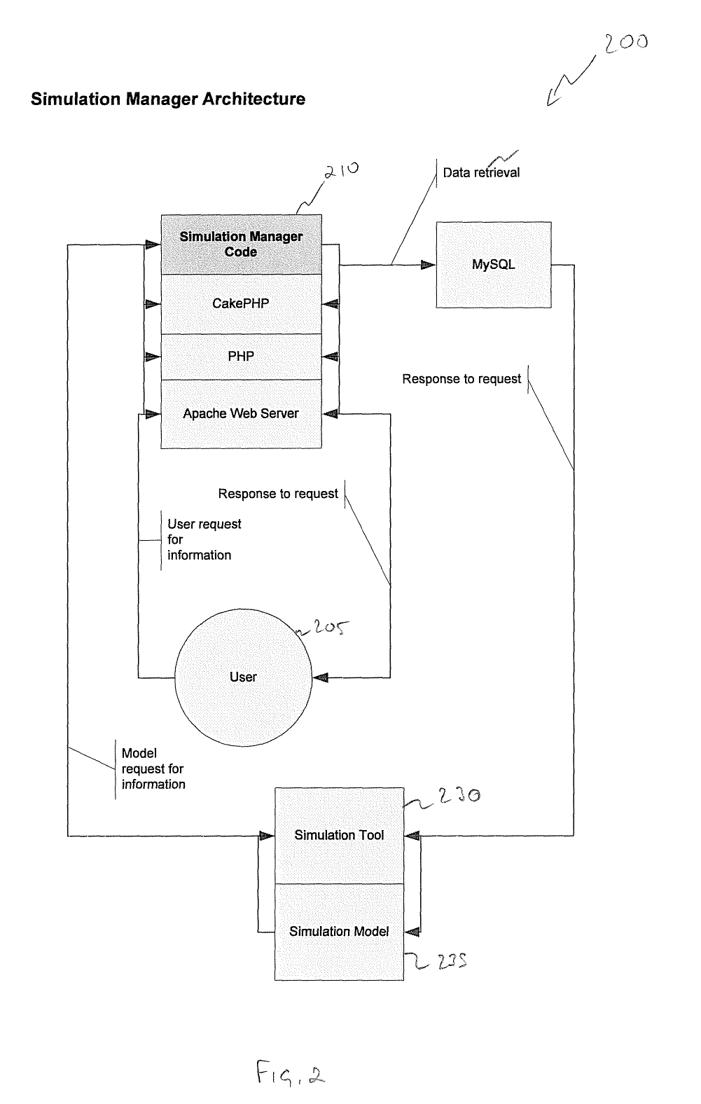

FIG. 2 shows a system according to an embodiment of the invention;

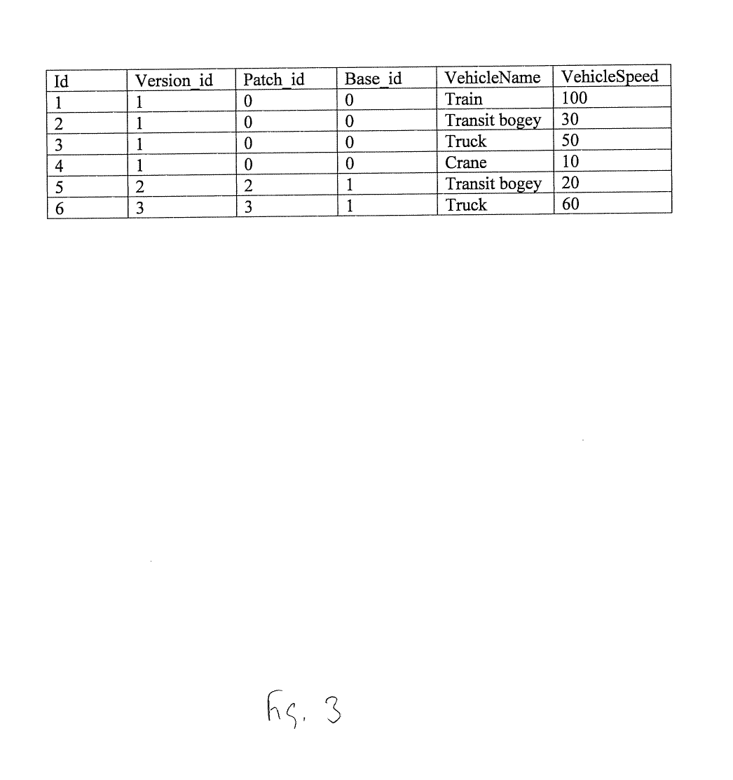

FIG. 3 shows a content of a database of apparatus according to an embodiment of the invention;

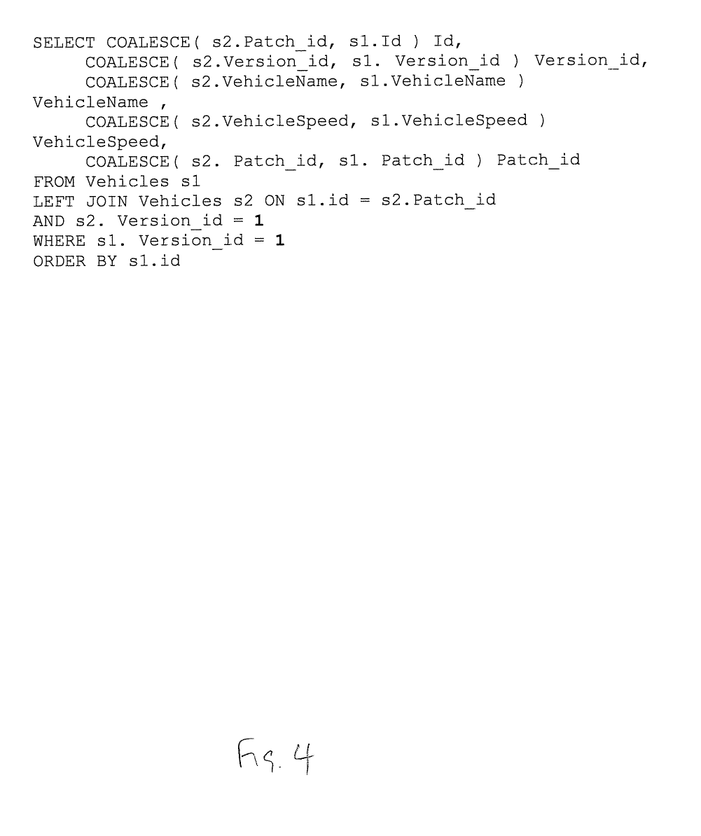

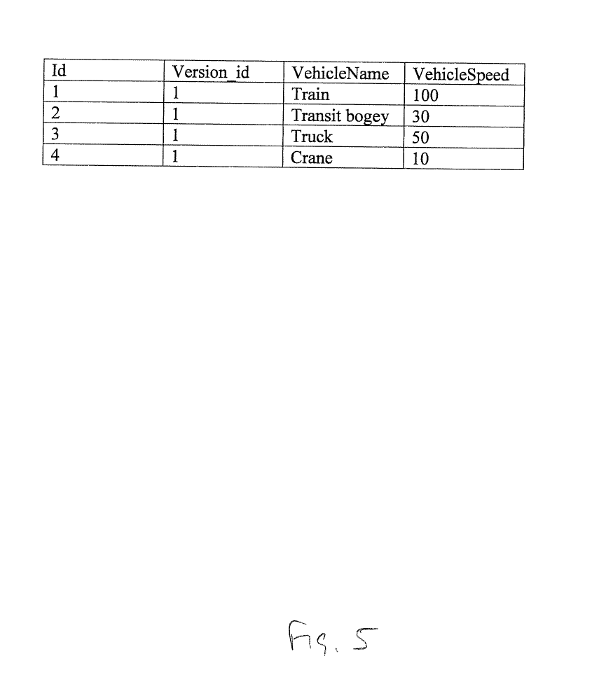

FIG. 4 shows SQL code arranged to output a table in the form of that of FIG. 5 from the database the content of which is shown in FIG. 3;

FIG. 5 shows a table generated from the database the content of which is shown in FIG. 3;

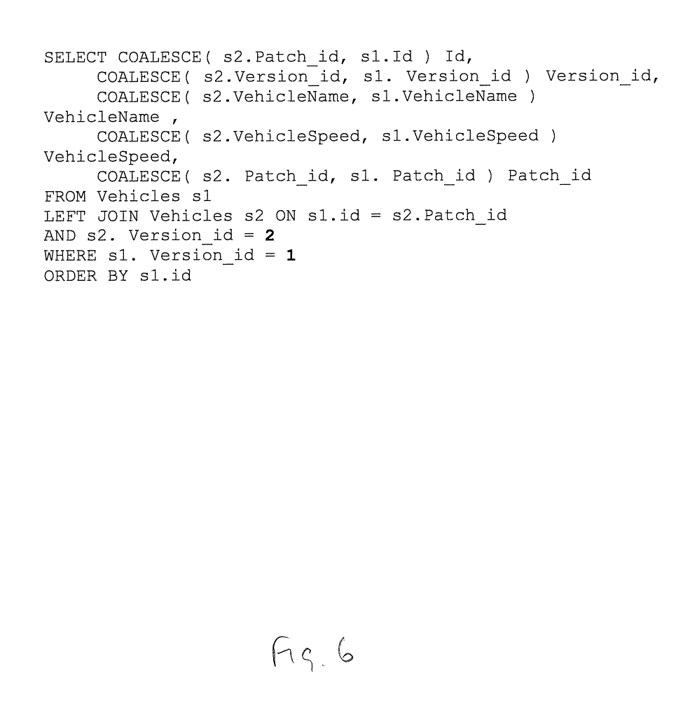

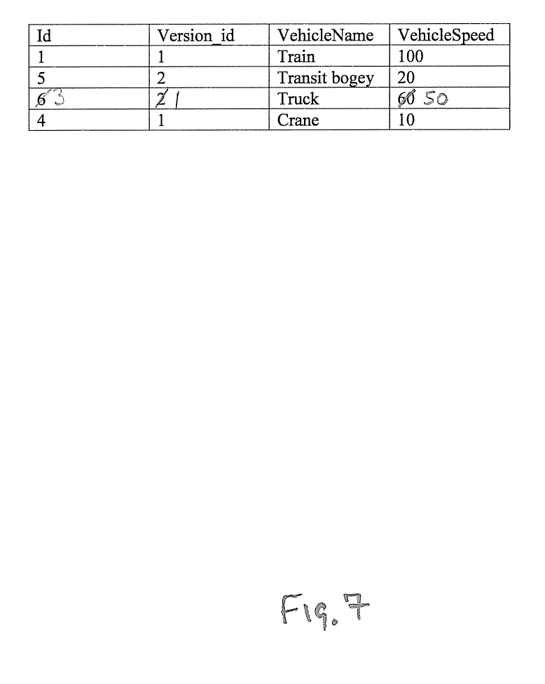

FIG. 6 shows SQL code arranged to output a second version of a table in the form of that of FIG. 7 from the database the content of which is shown in FIG. 3;

FIG. 7 shows the second version (version 2) of a table generated from the database the content of which is shown in FIG. 3;

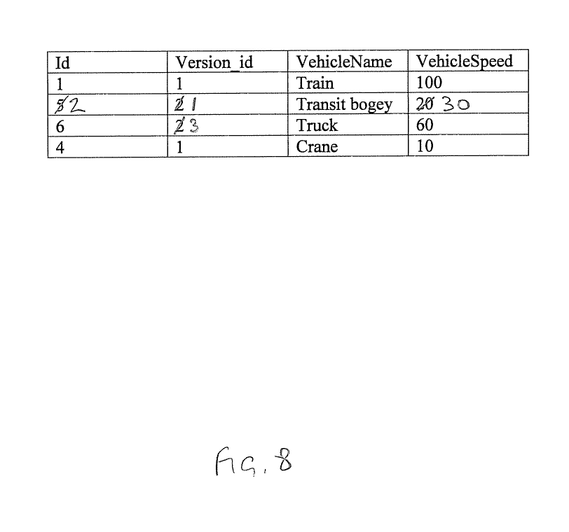

FIG. 8 shows version 3 of a table stored in the database the content of which is shown in FIG. 3;

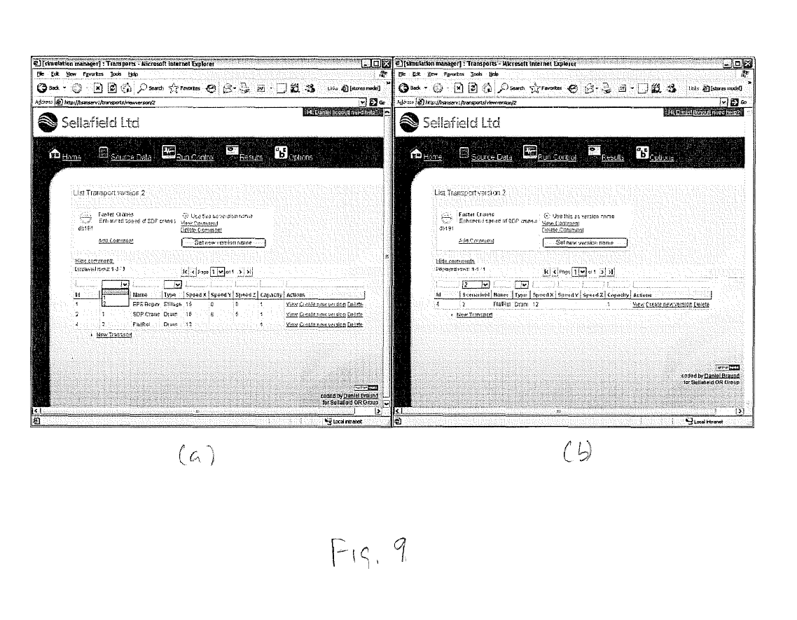

FIG. 9(a) and (b) show screen shots taken from apparatus according to an embodiment of the invention;

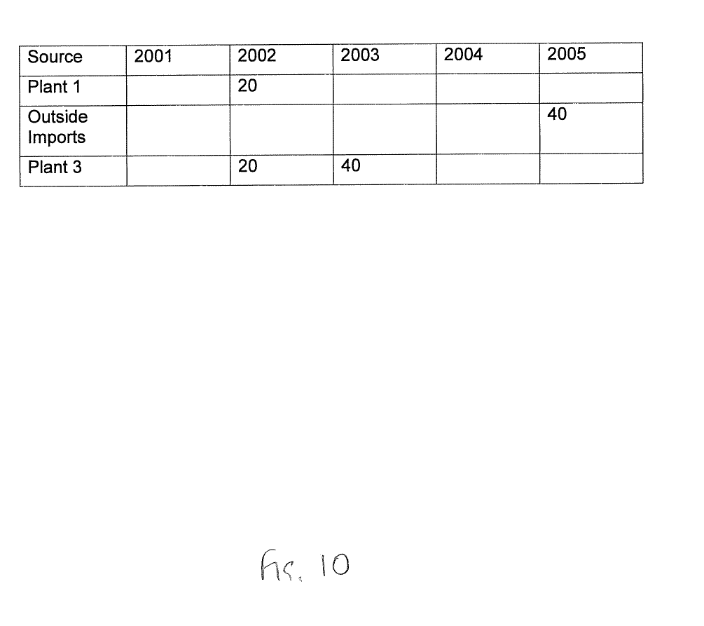

FIG. 10 shows a table of data elements in pre-normalised form;

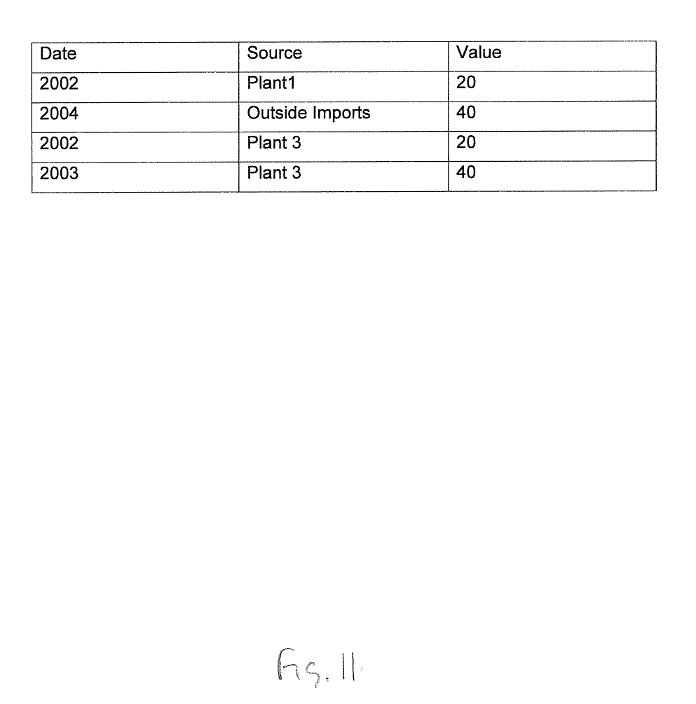

FIG. 11 shows a table of data elements following a first normalisation process;

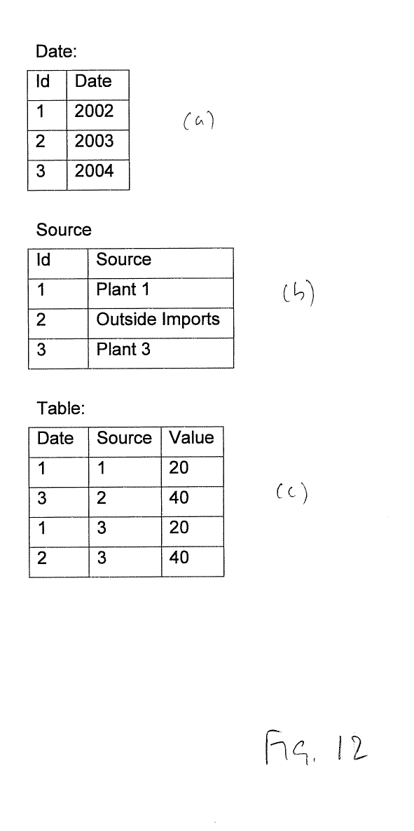

FIG. 12 shows (a) a look-up table of Dates, (b) a look-up table of Sources and (c) the table of FIG. 11 following second and third normalisation processes using the look-up tables shown in (a) and (b);

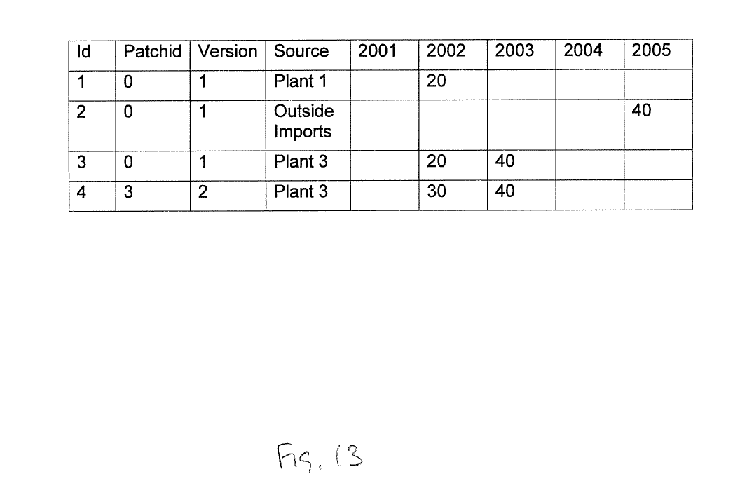

FIG. 13 shows a set of records of a database representing the table of FIG. 10;

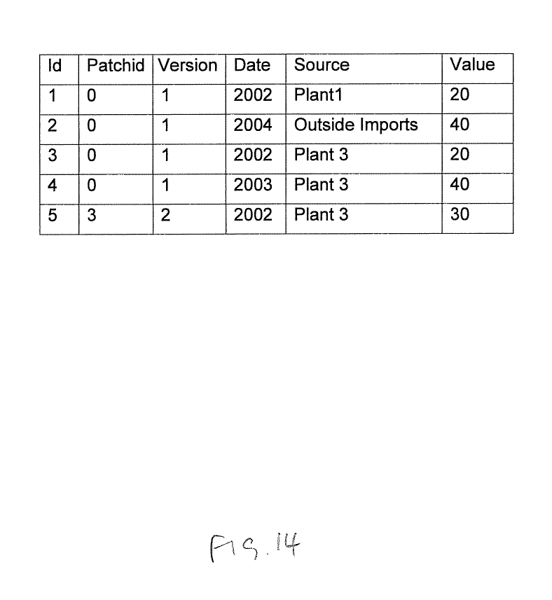

FIG. 14 shows a set of records of a database corresponding to a normalised form of the records of FIG. 11;

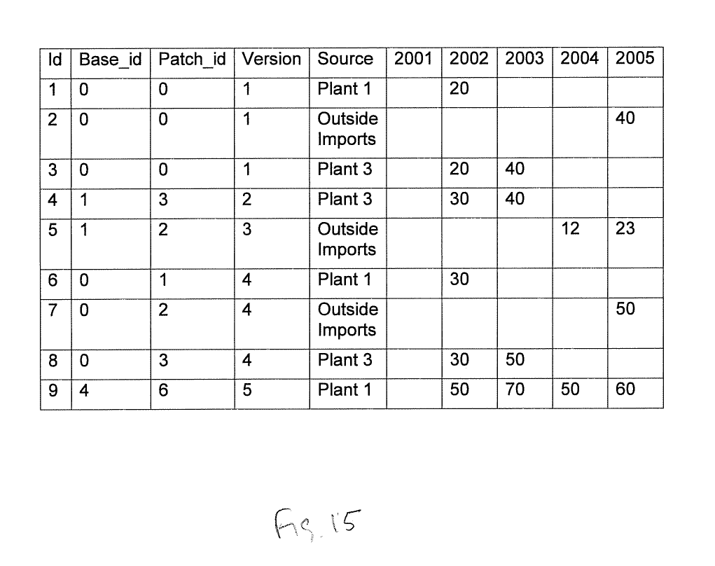

FIG. 15 shows a set of records of a database each record having an additional Base_id field;

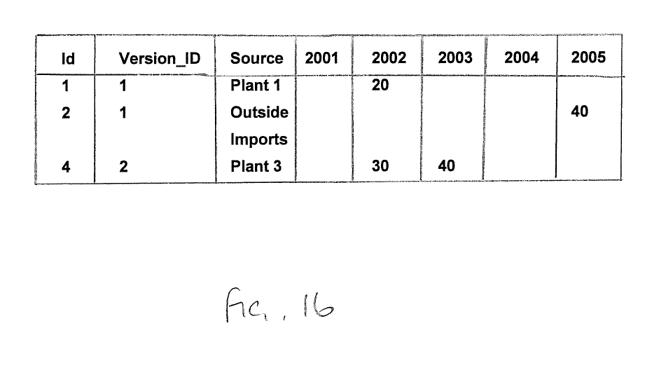

FIG. 16 shows a table generated from the set of records shown in FIG. 15 to reproduce a second version of the table; and

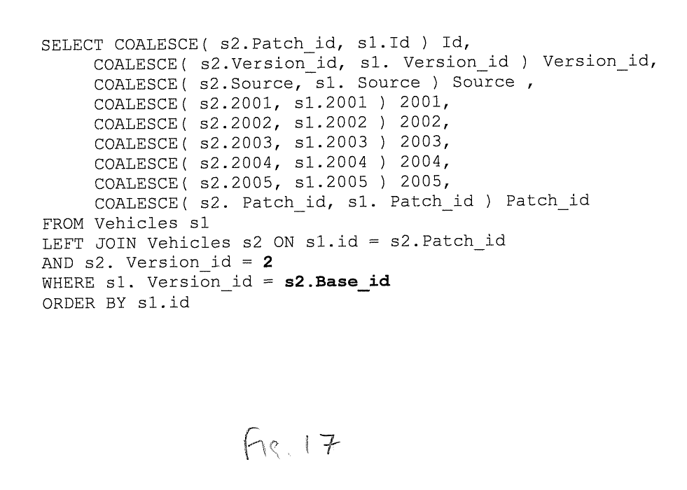

FIG. 17 shows an example of suitable SQL code arranged to generate the table of FIG. 16 from the records of FIG. 15.

### SPECIFIC DESCRIPTION

FIG. 1 is a schematic diagram of a known simulation management apparatus 100. The apparatus has a computing device 110 running a Microsoft Excel™ spreadsheet software application. The computing device 110 is arranged to allow a user to input data elements to the device and to store the data elements in a database in the form of a table of a spreadsheet. The spreadsheet is stored in a data storage apparatus 120. The data elements are arranged to provide input parameters for a simulation model 135 to be run using a simulation tool software application 130.

The simulation tool software application 130 is also run on a computing device which may be a server or other computing device, or the same computing device 100 that is running the spreadsheet software application.

The table input by the user to the spreadsheet 110 may be updated by the user and the entire dataset saved as a new version of the table, or saved so as to overwrite a previous version of the table.

According to an embodiment of the present invention, a computing system 200 is provided as shown schematically in FIG. 2. The system is provided in the form of a web server 210 running a WAMP stack.

It is to be understood that the term WAMP stack refers to a set of open source software applications commonly used in web server environments. A WAMP stack provides an operating system, database application, web server application and web scripting application. In a WAMP stack the operating system is Microsoft Windows™, the Web server application is provided by Apache™, the database application and database components are provided by MySQL™ and in the case of one embodiment of the present invention a dynamic web scripting language is provided by PHP™. Other applications are also useful including Perl and Python™.

The computing system 200 runs a simulation manager software application implemented in PHP™ and utilises a CakePHP™ Model View Controller (MVC) framework. It is to be understood that MVC is an architecture that separates application logic used to modify data (Controller) from the data (Model) and the display of the data (View). The MVC architecture can allow certain software applications to be implemented much faster, with less repeated code and in a way that is relatively simple to understand.

It is to be understood that embodiments of the invention are not limited to being implemented using the above mentioned software applications and the Windows operating system. Other software applications and operating systems are also useful including Linux™ and any other suitable operating system. In some embodiments of the invention a LAMP stack is used (Linux™, Apache™, MYSQL™ and PHP™, Perl or Python™ arranged in a manner corresponding to that of a WAMP stack).

The simulation manager software application is arranged to allow a user 205 to input values of data elements of a table to the computing system 200 in order to establish the table in the form of a dataset of data elements. The dataset is used to provide a set of input parameters for a simulation model 235 run by a simulation tool software application 230.

In some embodiments the simulation tool 230 is arranged to provide an output dataset to a simulation manager application, the output dataset representing an output of the simulation model 235 run by the simulation tool 230. This output dataset may be reviewed by the user 205 using the simulation manager application 210.

The simulation manager application is arranged to allow the user 205 to input and store the set of input parameters in the form of a baseline table, the baseline table being input as a baseline dataset by the user. Thus, the baseline dataset contains one or more data elements corresponding to a ‘baseline version’ of the table.

The baseline dataset is stored in a database in the form of a plurality of records. An example of a content of a database containing a baseline dataset is presented in FIG. 3. The database shown contains six records and in this particular example the baseline dataset is represented by only those records having a version identifier (stored in the Version_id field of each record) having a value equal to 1. The remaining records relate to modified versions of the baseline dataset as discussed below.

In the example shown in FIG. 3 the baseline dataset contained in the first four records is a first version of a table and relates to vehicles and their speeds. Each record of the dataset has an Id field, a Version_id field, a Patch_id field, a Base_id field, a subject field (in this example the subject field of each record contains the name of a vehicle) and a parameter field (in this example the parameter field contains a value of the speed of the vehicle that that record corresponds to).

The Id field of each record contains a unique identifier by means of which one record can be distinguished from all other records. In the example of FIG. 3 the value of each successive Id field is incremented by ‘1’ relative to the previous record in the database thereby to provide the unique identifier. Other arrangements are also useful.

It is desirable to allow a user to change the value of one or more data elements of a baseline version of the table stored in the database thereby to create a new ‘version’ of the table.

The reason for making such changes may be to provide a new set of parameters to be input to a simulation model being run by the simulation tool. For example, it may be desirable to provide a new set of parameters in order to test the effect of different vehicle speeds on the output of a given process that is being simulated by the simulation model.

Thus, the simulation manager application (or a related application) is arranged to allow a user to input a revised value of one or more data elements of the table with respect to a baseline version of the table in order to create a new version of the table. The application allows the new version of the table to be stored in the database for later retrieval and further amendment.

Rather than changing the value of one or more data elements stored in fields of the existing one or more records of the database corresponding to the baseline version of the table, the application is arranged to add to the database a new record for each existing record that is to be changed relative to the ‘baseline’ version of the table.

For a given new version of the table, the value stored in the Version_id field of each new record corresponding to that new version of the table will contain the same number, being a number indicative of the version of the table the record belongs to. The version number of a given version of the table is arranged to be incremented by 1 relative to the previous version. Other arrangements are also useful.

In the example of FIG. 3 only one parameter field of the baseline dataset was changed in order to create a second version of the table, i.e. only the value stored in the field corresponding to the speed of the vehicle named ‘Transit bogey’ was changed. It can be seen that in order to store the second version of the table, a new record was created and given an Id of 5 and a Version_id of 2 (being a record corresponding to version 2 of the table).

The Patch_id field of each new record corresponds to the Id of the record of the baseline dataset that the new record is intended to replace. As can be seen from FIG. 3, the record with an Id of 2 is the record corresponding to the speed of the Transit bogey, thus the value of the Patch_id field of the new record with an Id of 5 is set to 2. The new record is intended effectively to act as a ‘patch’ over the record with an Id of 2 to define the second version of the table.

A further version of the baseline dataset is also contained in the database presented in FIG. 3. The most recent record has an Id field having a value of 6 and a Version_id field having a value of 3 indicating that this record belongs to a third version of the baseline dataset. This record has a subject field containing the identifier ‘Truck’, and corresponds to the record of the baseline dataset having an Id of 3. Thus the Patch_id of this record is set to 3. Thus, version 3 of the table is the same as the baseline version except that the Truck Speed has a value of 60, not 50.

As discussed above the simulation manager application is implemented using SQL. The application is configured to output a dataset containing only data elements of the baseline dataset thereby reproducing the original table, or only data elements corresponding to any required version of the baseline dataset thereby reproducing a revised version of the table.

For example, by applying the SQL code of FIG. 4, the baseline version of the table shown in FIG. 5 can be constructed from the data stored in the database, a representation of the content of which is provided in FIG. 3 as discussed above. Thus, only records in the database having a Version_id field having a value of 1 are retrieved from the database.

It is to be understood that in some embodiments the simulation manager software application is configured to output this data (or data corresponding to any required version of the baseline table) to the simulation tool 230.

In some embodiments the simulation tool 230 is arranged to access data elements corresponding to a required version of a table directly.

By applying the SQL code of FIG. 6 data elements corresponding to the first revised version of the baseline version of the table (or ‘baseline table’), i.e. version 2 of the baseline table, may be displayed, as shown in FIG. 7.

It can be seen that the SQL code is arranged to recreate version 2 of the table with the vehicle names in the same order as that of the baseline table.

In version 2 of the table, only the Transit bogey speed changed relative to the baseline version (the original version of the table, i.e. version 1). Thus, the version 2 table is constructed from all of the records corresponding to the baseline table except the record corresponding to the Transit bogey (the record having an Id value of 2). Thus the record with an Id of 5 is used to construct line 2 of the data elements of the table (the version 2 record for the Transit bogey) instead of the record with Id of 2.

FIG. 8 shows version 3 of the table stored in the database the content of which is shown in FIG. 3. If one or more data elements corresponding to (say) version 3 of the table are required to be output the application is arranged to output this version of the table by accessing one or more data elements corresponding to version 3 of the baseline dataset. In other words, if a record for a particular vehicle was changed in version 3 of the baseline dataset this updated record of that vehicle will be used to construct the table. If no such update of a data element of that vehicle was made in version 3, the original version of the data element for that vehicle (i.e. the value stored in the corresponding record created when the baseline dataset was stored) is used to construct the table.

In this particular example, in version 3 of the table the only change was to the speed of the vehicle named Truck and therefore only one new record was created when this version of the table was stored. Thus, a new record is created in the database immediately after the last record (corresponding to version 2 of the table). This new record is the record with an Id field having a value of 6 (or in other words an Id value of 6), a Version_id of 3, a VehicleName field containing the identifier ‘Truck’ and a VehicleSpeed field containing the revised speed of the Truck (in this case a value of 60).

The software application automatically recreates the third version of the table using the Truck record with a Version_id of 3, and the Train, Transit bogey and Crane records with Version_id id's of 1.

It is to be understood that the number of versions of a table that may be stored and retrieved is limited only by the available storage capacity of the database. It is to be understood that more than one database may be used to store the data.

It is to be understood that it is also possible to display only the records that have changed in one version relative to a baseline version using a relatively short length of SQL code. This feature can be particularly useful when auditing the differences between two versions of the same table.

In some embodiments the software application is arranged to allow a user to select a particular version of the table and to view only values of the data elements of that table that are different from corresponding data elements of the baseline version of the table.

FIG. 9(a) is a screenshot of a display of all data contained in a database relating to a particular data table of Transport vehicles. The table contains data relating to three transport vehicles, these being an EPS Bogey, an SDP Crane and a FlatRol.

Records with Id field values of 1, 2 and 4 correspond to records relating to speeds of the Bogey, Crane and FlatRol respectively and form a baseline dataset.

FIG. 9(b) is a screenshot of a configuration of the application in which a user has elected to display only data elements that changed when version 2 of the table was created. It can be seen that only one data element changed, corresponding to the FlatRol vehicle.

The simulation manager software application may also be configured to allow a user to define a ‘scenario’ for a simulation model that is to be run. A scenario is a collection of versions of different tables that are to be used to provide data to the simulation model. Since multiple versions of each table may be stored in a database, the user must select which version of each table is to be used for each scenario.

Thus, the application is arranged to request a user to select which version of a given table is to be used by the simulation model for a given simulation scenario. In some embodiments the application may be arranged to establish a variable with a name such as $VehiclesVersion to contain the required version number of the table named Vehicles for the particular scenario. The simulation tool may be arranged to subsequently retrieve data corresponding to the required version of the Vehicles table using appropriate SQL scripts as discussed above.

For example, in the above example the line

AND s2. Version_id=2
of the SQL script of FIG. 6 might be replaced with the line
AND s2. Version_id=$VehiclesVersion
where $VehiclesVersion is a variable which contains the number of the version of the Vehicles table that the user wishes to use. In some embodiments the value of the variable is set from a pre-populated dropdown list which is set by selecting all unique values from the version_id field of records of the database corresponding to the table.

The data may in some embodiments be imported into a global table or array for use by the simulation model using a nested loop. In some embodiments required SQL statements are generated by the application itself (i.e. programmatically). The SQL statements may be generated so as to correctly access data elements of records of a given table, since the number of fields of a record and the number of parameters associated with a record that are required for the simulation model may differ from one table to another and/or from one scenario to another.

In some embodiments of the invention normalization of a table is performed in order to reduce an amount of space required to store a given table or set of tables in the database. It is to be understood that normalization of a table may be particularly useful when handling time-based input data for a model.

An example of a table of time-based data to be used as an input to a simulation model is shown in FIG. 10. It can be seen that a number of fields of each row of the table are empty. In known spreadsheet software packages these empty fields would occupy memory of the storage device in which a spreadsheet containing the table was stored, despite the fact that the fields are empty.

FIG. 11 shows a normalised version of the table of FIG. 10. The table has no blank fields since the only entries in the table are those corresponding to dates for which data is available. Thus, each Value of a speed of a Source is listed in one column of the table, separate columns being provided to contain a Date and Source corresponding to the Value.

It is to be understood that this feature of some embodiments of the invention has the advantage that a reduced amount of storage space is required of a storage medium in order to store a set of records corresponding to a given table.

The use of an MVC architecture allows an SQL statement to be used to retrieve the data in such a way that the table can be displayed in an Excel™ table format.

In the table of FIG. 11 it can be seen that a number of entries in the table are repeated, such as the entry corresponding to the year 2002 and source Plant 3. The table can be further normalised by establishing separate tables to improve an efficiency of storage of the table.

FIG. 12(a) shows a table of Dates, each date being assigned a unique Date Id number (1 to 3 in this example). Similarly, FIG. 12(b) shows a table of Sources, each source being assigned a unique Source Id number. Thus, the table of FIG. 11 may be rewritten using the tables of FIG. 12(a) and (b) in the form shown in FIG. 12(c). Here, the Date Id numbers of FIG. 12(a) and the Source Id numbers of FIG. 12(b) are substituted for the Date year numbers and Source names of FIG. 11.

It is to be understood that a substantial reduction in the amount of memory required to store a given table may be achieved in some embodiments. It is also to be understood that in some other embodiments a table that has been subject to normalization may in fact occupy a larger amount of memory than it did in its state pre-normalization.

Display of a table in a normalized state has the further advantage that it can improve a readability of the table and make fields of the table that have been changed easier to identify.

FIG. 13 shows an example of a content of a database according to an embodiment of the invention containing data elements relating to two different versions of a table. The database contains a baseline dataset (records with Id values of from 1 to 3) and a new record (having an Id value of 4) being a record corresponding to a new version of the dataset. The record with an Id value of 4 has a Patch Id value of 3, meaning that this record is intended to replace the record having an Id value of 3, thereby creating version 2 of the table.

As discussed above, a new record has been created (rather than an old record changed by being overwritten) in order to facilitate auditing of the table at a later date, allowing all changes made to the table to be viewed in a convenient manner. As discussed above, in the example of FIG. 13 the record with an Id field having a value of 4 is the new record.

Each record of the database of FIG. 13 contains a number of blank fields which occupy memory of the storage device in which the database is stored. It can be identified upon close inspection of FIG. 13 that the difference between version 1 of the table and version 2 of the table is that the value of a parameter associated with Plant 3 in the field corresponding to the year 2002 was changed from 20 to 30 when version 2 of the table was created. However, it is to be understood that identifying the field that has changed in a record having tens or hundreds of values of a given parameter (such as year) may not be as easy as the example of FIG. 13.

An alternative way of storing the data is to have a separate record for each data element of the table represented by FIG. 13. Thus, in the case of a record of FIG. 13 that contains only one data element of the table (such as the record with an Id field having a value of 1), still only one record would be required. However, in the case of a record containing values of two parameters (such as the record with an Id field having a value of 3), two separate records would be required.

FIG. 14 shows a table arranged in this manner. The baseline dataset of the table now comprises four records (Id values 1 to 4), the records with Id values of 3 and 4 corresponding to values of the parameter associated with Plant 3 for the years 2002 and 2003 respectively. Significantly, there are no blank fields in any of the records of FIG. 14, in contrast to the corresponding records of FIG. 13.

It can be seen by inspection that the record in the database represented in FIG. 14 having an Id value of 5 corresponds to a value of the parameter of Plant 3 in 2002 in version 2 of the table.

It can be readily seen by inspection of the data of FIG. 14 that the only change to the baseline dataset made in version 2 of the dataset relates to the value of the parameter of Plant 3 for the year 2002. Identifying the change is substantially easier in the representation of FIG. 14 than that of FIG. 13, particularly when data elements corresponding to a greater number of dates are provided.

Thus, it is to be appreciated that embodiments of the invention provide a display of data that is more readily interpretable than prior art displays. Furthermore, an amount of storage space required for the storage of tables and updated versions of tables of data is reduced in some embodiments relative to prior art methods of storing and updating tables.

Some embodiments of the invention are particularly useful in environments in which access to a table by multiple users is desirable. In prior art systems, a user typically emails or otherwise sends a copy of a table in a spreadsheet format (such as Microsoft Excel™ format) to one or more other users. A disadvantage is that each user is unable to know whether any changes have been made to the table since they received their copy of the table. Furthermore, if a user modifies the table and returns the table to a table administrator, the table administrator may not be able to identify quickly which (if any) fields of the table have been changed.

In some embodiments of the invention, the use of web-based technology enables any user to view a specific table or row of a table for which they have view permission by means of a hyperlink that may be emailed to them or (for example) embedded in another document such as a Microsoft Word™ document or a pdf document.

In some circumstances it may be required to perform a ‘baselining’ operation in which a version of the data is selected to become a new baseline dataset. In keeping with a requirement of some embodiments of the invention to hold a full audit trail, the original baseline dataset is not deleted. Rather, in some embodiments a further field is included with each record, referred to herein as a ‘Base_id’ field. It is to be understood that in some embodients the Base_id field is not included.

The Base_id field of a record contains a value representing the identity of the baseline dataset of which the record is a modification.

Records of the original baseline dataset (i.e. version 1 of the baseline dataset) are not themselves modifications of any other baseline dataset, and therefore have a value of Base_id of 0. Subsequent records stored in the database representing modified records of the original baseline dataset are provided with a Base_id of 1, indicating that they relate to Version 1 of the baseline dataset (records having a Version id of 1). An example of this is shown in the database the content of which is shown in FIG. 15, corresponding to a particular table and several versions thereof.

The baseline may be changed to a new baseline by storing in the database a set of records corresponding to a revised version of the baseline dataset, each of the records of the new version corresponding to a record of the baseline dataset. This may be seen in the database the content of which is shown in FIG. 15.

FIG. 15 shows a set of records wherein each record has an additional Base_id field. FIG. 16 shows a table generated from the records shown in FIG. 15, the table having been generated so as to reproduce a second version of the table. FIG. 17 shows an example of suitable SQL code arranged to generate the table of FIG. 16 from the records of FIG. 15.

In the database the content of which is displayed in FIG. 15 records relating to version 4 of the table are stored, version 4 being a new baseline dataset for the table. Thus the records relating to version 4 (records with Id values of 6, 7 and 8) are each given a Base_id value of 0 although their Patch_id values still correspond to the Id values of the corresponding records of the original baseline dataset, i.e. the records with Id values of 1, 2 and 3.

As discussed above, in the example of FIG. 15, the records corresponding to version 4 of the table represent a new baseline dataset. Thus, new records subsequently added, representing further changes to the table, are provided with a Base_id field having a value of 4, indicating that they are records for which the baseline dataset is provided by version 4 of the original baseline dataset. Because records relating to version 4 of the original baseline dataset form the new baseline dataset, the Patch_id value of each subsequent record refers to the Id of a record having a Version_id of 4, rather than a Version_id of 1.

In FIG. 15 the ninth record of the database (the record having an Id value of 9) is a record that represents four values of certain parameters of a source (Plant 1) of the second baseline dataset, i.e. four values of the fourth version of the original baseline dataset. The value of the Base_id field of the ninth record is therefore set to 4 and the value of the Patch_id field is set to 6 indicating that the record is intended to replace the record having a value of the Id field of 6 (i.e. the record relating to Plant 1) when it is required to recreate the second version of the revised baseline dataset.

The second version of the revised baseline dataset corresponds to the fifth version of the original baseline dataset, and therefore the value of the Version field of the new (ninth) record is set to 5.

It is to be understood that in some embodiments other fields of a record such as the name of the source may be required to be changed relative to the content of the field when the record was originally created. For example, a spelling mistake may have been made, or a different brand or type of vehicle or other object may now be being used instead of a previous vehicle or object.

In some embodiments it is important to be able to accommodate such changes without changing previous records so as to preserve an audit trail of all changes made to a database. This is important in situations where auditing of all changes made to a table is an imperative.

Thus, if it is required to change the content of the Source field of the record having an Id of 9 (‘record 9’) from “Plant 1” to “Plant 1v2”, a new record could be entered with a Source field containing the title “Plant 1v2” together with parameters associated with Plant 1v2. The Patch_id of this new record would be the Id number of the record of the baseline dataset that the record is intended to replace in the usual manner.

It is to be understood that some embodiments of the invention may be used to provide input tables for a range of software applications. For example, some embodiments of the invention may be used to provide input tables for models of systems such as financial markets, traffic movement and movement of objects such as persons and/or baggage and/or cargo through an airport or other environment.

Some embodiments of the invention may be used to store tables of data for the control of physical equipment and systems such as motors, servos and other devices.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. Apparatus arranged to allow a user to input a plurality of values of data elements of a table being a baseline version of the table having a version number b, the apparatus being arranged to store the values of the data elements in a database in the form of one or more baseline version records, each record containing at least one of the values of the data elements,
the apparatus being arranged to allow a user to input a revised value of one or more of the data elements of the table thereby to define a difference dataset representing the value of one or more data elements of a (b+n)th version of the table that are different from the value of one or more corresponding data elements of the (b) th version of the table,
the apparatus being arranged to store the difference dataset by generating one or more further records of the database, each further record corresponding to a baseline version record, each further record containing at least one value of a data element of the difference dataset,
the apparatus being further arranged to store in the database an identifier indicative of an identity of the version of the table to which each of the one or more further records corresponds.

2. Apparatus as claimed in claim 1 arranged to output upon request the value of one or more data elements of an m′th version of the table stored in the database where m≦b+n.

3. Apparatus as claimed in claim 1 wherein each record of the database is provided with a version identifier indicative of the identity of the version of the table to which that record corresponds.

4. Apparatus as claimed in claim 1 wherein each record is further provided with an identifier unique to that record.

5-7. (canceled)

8. Apparatus as claimed in claim 1 further arranged to execute a simulation application.

9-10. (canceled)

11. Apparatus as claimed in claim 1 arranged to receive a user identifier corresponding to an identity of a user responsible for entering into the apparatus a data element of a difference dataset and to determine whether the user identifier corresponds to a user authorized to enter a data element into the apparatus.

12-15. (canceled)

16. Apparatus as claimed in claim 1 arranged to output a required version of a table to a visual display unit of the apparatus upon request.

17. Apparatus as claimed in claim 1 wherein data elements may be input to the apparatus by a user manually by means of an input device, the input device being optionally selected from amongst a keyboard, a mouse and a touch screen.

18. Apparatus as claimed in claim 1 wherein data elements may be input to the database from a file provided to or generated by the apparatus or from a file stored externally with respect to the database.

19. (canceled)

20. Apparatus as claimed in claim 1 wherein records of the database are provided with a field containing a value of a baseline identifier, the baseline identifier providing an indication as to whether the record contains one or more data elements of a baseline version of the table, a baseline version being a reference version with respect to which one or more further records of the database represent one or more data elements of a difference dataset.

21-23. (canceled)

24. A method of storing multiple versions of a table in a database, the method comprising:
inputting a plurality of values of data elements of a table being a baseline version of the table having a version number b;
storing the values of the data elements in a database in the form of one or more baseline version records, each record containing at least one of the values of the data elements;
inputting a revised value of one or more of the data elements of the table thereby to define a difference dataset representing the value of one or more data elements of a (b+n)th version of the table that are different from the value of one or more corresponding data elements of the b′th version of the table;
storing the difference dataset by generating one or more further records of the database, each further record corresponding to a baseline version record, each further record containing at least one value from the difference dataset; and
storing in the database an identifier indicative of an identity of the version of the table to which each of the one or more further records corresponds.

25. A method as claimed in claim 24 further comprising the step of outputting upon request the value of one or more data elements of an m′th version of the table stored in the database.

26. A method as claimed in claim comprising the step of providing each record of the database with a version identifier indicative of the identity of the version of the table to which that record corresponds.

27. A method as claimed in claim 24 further comprising providing each record with an identifier unique to that record.

28-30. (canceled)

31. A method as claimed in claim 24 further comprising the step of executing a simulation application.

32-33. (canceled)

34. A method as claimed in claim 24 comprising receiving a user identifier corresponding to an identity of a user responsible for entering into the apparatus a data element of a difference dataset and determining whether the user identifier corresponds to a user authorized to enter a data element into the apparatus.

35-38. (canceled)

39. A method as claimed in claim 24 comprising outputting a required version of a table to a visual display unit upon request.

40. A method as claimed in claim 24 comprising receiving data elements input by a user manually by means of an input device, the input device being optionally selected from amongst a keyboard, a mouse and a touch screen.

41. A method as claimed in claim 24 comprising inputting data elements to the database from a file provided to or generated by the apparatus or from a file stored externally with respect to the database.

42. (canceled)

43. A method as claimed in claim 24 comprising providing each record with a field containing a value of a baseline identifier, the baseline identifier providing an indication as to whether the record contains one or more data elements of a baseline version of the table, a baseline version being a reference version with respect to which one or more further records of the database represent one or more data elements of a difference dataset.

44-48. (canceled)
